(19) United States
(12) Patent Application Publication
(10) Pub. No.: US 2025/0307493 A1
(43) Pub. Date: Oct. 2, 2025

(54) INFORMATION OUTPUT DEVICE, INFORMATION OUTPUT METHOD, AND COMPUTER PROGRAM

(71) Applicant: GS Yuasa International Ltd., Kyoto-shi, Kyoto (JP)

(72) Inventor: Toshihiro YABU, Kyoto-shi, Kyoto (JP)

(21) Appl. No.: 18/865,543

(22) PCT Filed: May 8, 2023
(86) PCT No.: PCT/JP2023/017222

§ 371 Date: Nov. 13, 2024

(30) Foreign Application Priority Data
May 16, 2022 (JP) 2022-080366

(51) Int. Cl. G06F 30/20; G06F 119/06

(52) U.S. Cl. CPC G06F 30/20; G06F 2119/06

(57) ABSTRACT

A receiving unit that receives input of required specifications related to an energy storage apparatus to be designed, a generation unit that generates a configuration plan of the energy storage apparatus including the number of energy storage cells to be mounted on the energy storage apparatus and arrangement of the energy storage cells based on a part of a condition included in the received required specifications, an evaluation unit that evaluates whether or not the generated configuration plan satisfies the required specifications, an update unit that updates the configuration plan according to an evaluation result of the evaluation unit and causes the evaluation unit to evaluate the updated configuration plan, and an output unit that outputs information on a configuration plan evaluated by the evaluation unit to satisfy the required specifications are included.

### CROSS REFERENCE TO RELATED APPLICATIONS

This application is a National Stage Application, filed under 35 U.S.C. § 371, of International Application No. PCT/JP2023/017222, filed May 8, 2023, which international application claims priority to and the benefit of Japanese Application No. 2022-080366, filed May 16, 2022; the contents of both of which as are hereby incorporated by reference in their entireties.

### BACKGROUND

### Technical Field

The present invention relates to an information output device, an information output method, and a computer program.

### Description of Related Art

A power storage facility including an energy storage apparatus that is charged with electricity by a power generator such as a solar cell or a wind power generator and is discharged as necessary has been widely used. A plurality of energy storage devices (energy storage cells) are mounted on the energy storage apparatus. Capacity (full charge capacity) of the energy storage apparatus decreases with repetition of charging and discharging (charge-discharge cycle) and elapse of time. A rate at which capacity of the energy storage apparatus deteriorates varies depending on a state of charge (SOC), that is, an amount of electric power stored in the energy storage apparatus.

Patent Document JP-A-2018-169393 discloses a technique for predicting capacity of an energy storage apparatus which decreases with repetition of charging and discharging and elapse of time. In Patent Document JP-A-2018-169393, decrease in capacity of the energy storage apparatus is predicted based on transition of an SOC.

### BRIEF SUMMARY

A manufacturer of an energy storage apparatus performs the following in order to present a configuration plan of the energy storage apparatus (energy storage facility) based on customer's required specifications.
(1) The manufacturer prepares a configuration plan of the energy storage apparatus such as the number of series connections and the number of parallel connections of energy storage cells.
(2) The manufacturer performs simulation (prediction) for a period (life) during which the energy storage apparatus having the determined configuration can satisfy a customer requirement under an assumed use environment.
(3) The manufacturer repeats trial and error of determination and simulation to determine a configuration plan of the energy storage apparatus considered to be optimal.

It is not easy for a sales representative or an inexperienced technical personnel to present a configuration plan of the energy storage apparatus that satisfies a customer requirement in consideration of various constraint conditions such as a discharge rate, battery temperature, and depth of discharge of the energy storage apparatus.

An object of the present invention is to provide an information output device, an information output method, and a computer program that present a configuration plan of an energy storage apparatus satisfying a customer requirement while considering a constraint condition in the energy storage apparatus.

An information output device according to one aspect of the present invention includes a receiving unit that receives input of required specifications related to an energy storage apparatus to be designed, a generation unit that generates a configuration plan of the energy storage apparatus including the number of energy storage cells to be mounted on the energy storage apparatus and arrangement of the energy storage cells based on a part of a condition included in the received required specifications, an evaluation unit that evaluates whether or not the generated configuration plan satisfies the required specifications, an update unit that updates the configuration plan according to an evaluation result of the evaluation unit and causes the evaluation unit to evaluate the updated configuration plan, and an output unit that outputs information on a configuration plan evaluated by the evaluation unit to satisfy the required specifications.

An information output method according to one aspect of the present invention executes, by a computer, processing of receiving input of required specifications related to an energy storage apparatus to be designed, generating a configuration plan of the energy storage apparatus including the number of energy storage cells to be mounted on the energy storage apparatus and arrangement of the energy storage cells based on a part of a condition included in the received required specifications, evaluating whether or not the generated configuration plan satisfies the required specifications, updating the configuration plan according to an evaluation result, and outputting information on a configuration plan evaluated to satisfy the required specifications.

A computer program according to one aspect of the present invention is a computer program for causing a computer to execute processing of receiving input of required specifications related to an energy storage apparatus to be designed, generating a configuration plan of the energy storage apparatus including the number of energy storage cells to be mounted on the energy storage apparatus and arrangement of the energy storage cells based on a part of a condition included in the received required specifications, evaluating whether or not the generated configuration plan satisfies the required specifications, updating the configuration plan according to an evaluation result, and outputting information on a configuration plan evaluated to satisfy the required specifications.

According to the above aspect, it is possible to present a configuration plan of an energy storage apparatus satisfying a customer's requirement while considering a constraint condition in the energy storage apparatus.

### BRIEF DESCRIPTION OF THE FIGURES

FIG. 1 is a schematic diagram illustrating a configuration example of a power supply system according to an embodiment.

FIG. 2 is a schematic diagram illustrating a configuration example of an energy storage apparatus.

FIG. 3 is a block diagram describing an internal configuration of an arithmetic device.

FIG. 4 is a flowchart illustrating a procedure of processing executed by the arithmetic device.

FIG. 5 is a schematic diagram illustrating an example of an input screen for receiving customer's required specifications.

FIG. 6 is a graph showing a relationship between depth of discharge and expected life.

FIG. 7 is a graph showing a relationship between environmental temperature and discharge capacity for each discharge rate.

FIG. 8 is a diagram illustrating a relationship between discharge current and end voltage.

FIG. 9 is a graph showing a relationship between discharge current and discharge time.

FIG. 10 is a schematic diagram illustrating an example of an output screen for displaying a configuration plan of the energy storage apparatus.

FIG. 11 is a flowchart illustrating a procedure of processing executed by the arithmetic device according to a second embodiment.

FIG. 12 is a flowchart illustrating a procedure of processing executed by the arithmetic device according to a third embodiment.

### DETAILED DESCRIPTION OF VARIOUS EMBODIMENTS

A lead-acid battery has a characteristic that dischargeable capacity varies depending on a discharge rate and battery temperature. For example, in a lead-acid battery, since use at depth of discharge of 100% leads to shorter life, it is necessary to provide a margin in capacity. Other than the above, since charge characteristics vary depending on battery temperature, there are various constraint conditions such as consideration of a temperature coefficient for charge voltage in order to avoid a poor charged state and overcharge. When designing an apparatus using a lead-acid battery or a lithium battery for cycle applications, a configuration plan of an energy storage apparatus is determined in consideration of various constraint conditions and proposed to a customer.

However, in order to consider various constraint conditions, it may be necessary to read a numerical value from a battery characteristic curve, or calculation itself may be complicated. Therefore, if required specifications are obtained from a customer, it is difficult for a sales department to respond, and it is necessary for a technical department to consider a configuration plan. By the above, there is a possibility that an impression that response is slow is given to the customer, and a customer satisfaction level is lowered. As a battery manufacturer's standpoint, there is a possibility of losing a business opportunity. A technical personnel also needs to have knowledge about a storage battery in order to execute calculation, and if knowledge is shallow, there is a possibility that a final configuration plan will not be reached.

In a case where a system is configured based on rated capacity without considering various constraint conditions of a battery, calculation is relatively easy. In a system requiring a high discharge rate, actual capacity of a battery is smaller than rated capacity, and thus, in order to satisfy required specifications, a device larger in scale than a configuration calculated with the rated capacity is required. In a case where a configuration plan calculated based on rated capacity is compared with a configuration plan considering various constraint conditions, the former configuration plan is more advantageous in terms of price. On the other hand, there is a possibility that the former configuration plan does not satisfy required specifications. If a battery manufacturer that presents the latter configuration plan cannot appropriately point it out, there is a possibility that the battery manufacturer will lose the order.

An information output device of the present disclosure includes a receiving unit that receives input of required specifications related to an energy storage apparatus to be designed, a generation unit that generates a configuration plan of the energy storage apparatus including the number of energy storage cells to be mounted on the energy storage apparatus and arrangement of the energy storage cells based on a part of a condition included in the received required specifications, an evaluation unit that evaluates whether or not the generated configuration plan satisfies the required specifications, an update unit that updates the configuration plan according to an evaluation result of the evaluation unit and causes the evaluation unit to evaluate the updated configuration plan, and an output unit that outputs information on a configuration plan evaluated by the evaluation unit to satisfy the required specifications.

Customer's required specifications received by the receiving unit include information on an energy storage cell used in an energy storage apparatus, information on inverter voltage, discharge specifications (discharge capacity, discharge output, discharge time, and the like), environmental temperature, the number of cycles, required life, and the like. A configuration plan generated by the generation unit includes the number and arrangement of energy storage cells mounted on an energy storage apparatus. The number and arrangement of energy storage cells are determined by the number of series connections and the number of parallel connections of energy storage cells, and a temporarily set value may be included at an initial stage of calculation. A generated configuration plan is evaluated by the evaluation unit and updated according to an evaluation result. The output unit outputs information on a configuration plan evaluated to satisfy customer's required specifications.

With the above configuration, when customer's required specifications are input, the information output device outputs a configuration plan of an energy storage apparatus satisfying the required specifications. For this reason, an operator can perform operation regardless of a knowledge level, and can present a customer with a configuration plan of an energy storage apparatus satisfying required specifications by causing the information output device to calculate the required specifications as soon as the operator obtains the required specifications.

Since a configuration plan output from the information output device is based on actual capacity in consideration of various constraint conditions, the number of energy storage cells required may be larger than that of a configuration plan calculated by rated capacity. However, by outputting not only a finally obtained configuration plan but also a calculation process, it is possible to prove to a customer that an optimum configuration plan is presented. Therefore, as a result, there is a high possibility that a configuration plan presented by the information output device of the present disclosure is employed even if the configuration plan is disadvantageous in terms of price.

Furthermore, even in application of cycle discharge in which a load on a battery is high, required specifications can be satisfied by appropriately considering various constraint conditions. This makes it possible to exhibit required performance in a required life period even in cycle applications, giving a customer an impression of high product quality.

The required specifications may include discharge specifications and voltage converted by an inverter included in a power supply system with respect to power discharged from the energy storage apparatus. According to this configuration, the number of series connections of energy storage cells is calculated from inverter voltage that is a partial condition of required specifications, and actual capacity is calculated from discharge specifications.

The generation unit may generate the configuration plan by calculating the number of series connections of the energy storage cells and provisionally setting the number of parallel connections of the energy storage cells based on voltage converted by an inverter included in the power supply system and specifications of the energy storage cell with respect to power discharged from the energy storage apparatus. According to this configuration, the number of series connections of energy storage cells is calculated from required specifications. On the other hand, an initial number of parallel connections is provisionally set.

The evaluation unit may calculate the number of series connections and the number of parallel connections of energy storage cells required from discharge specifications of the energy storage apparatus, and evaluate whether or not the configuration plan satisfies the required specifications according to whether or not a provisionally set number of parallel connections and the calculated number of parallel connections coincide with each other. According to this configuration, whether or not required specifications are satisfied is evaluated according to whether or not the number of parallel connections calculated from the required specifications coincides with a provisionally set number of parallel connections.

The evaluation unit may derive maximum allowable discharge time from discharge current calculated based on the configuration plan, and evaluate whether or not the configuration plan satisfies the required specifications according to whether or not the derived maximum allowable discharge time satisfies discharge time given as the discharge specifications. The maximum allowable discharge time is dischargeable time calculated in consideration of depth of discharge with respect to dischargeable time (that is, time required for discharging from full charge to end-of-discharge voltage) of an energy storage apparatus. In a case where dischargeable time is T and depth of discharge is 50%, the maximum allowable discharge time is calculated as T/2. According to the above configuration, the maximum allowable discharge time in consideration of required depth of discharge can be derived, and in a case where the derived maximum allowable discharge time is longer than discharge time required by a customer, customer specifications are evaluated to be satisfied.

The update unit may change the provisionally set number of parallel connections in a case where the evaluation unit evaluates that the configuration plan does not satisfy the required specifications. According to this configuration, it is possible to sequentially change the number of parallel connections of energy storage cells to derive a configuration plan of an energy storage apparatus that satisfies customer's required specifications.

A display unit that displays a receiving screen for receiving input of the required specifications may be provided. According to this configuration, it is possible to present a configuration plan of an energy storage apparatus at a meeting with a customer.

An information output method of the present disclosure executes, by a computer, processing of receiving input of required specifications related to an energy storage apparatus to be designed, generating a configuration plan of the energy storage apparatus including the number of energy storage cells to be mounted on the energy storage apparatus and arrangement of the energy storage cells based on a part of a condition included in the received required specifications, evaluating whether or not the generated configuration plan satisfies the required specifications, updating the configuration plan according to an evaluation result, and outputting information on a configuration plan evaluated to satisfy the required specifications. According to this configuration, it is possible to present a configuration plan of an energy storage apparatus satisfying a customer's requirement while considering a constraint condition in the energy storage apparatus.

A computer program of the present disclosure causes a computer to execute processing of receiving input of required specifications related to an energy storage apparatus to be designed, generating a configuration plan of the energy storage apparatus including the number of energy storage cells to be mounted on the energy storage apparatus and arrangement of the energy storage cells based on a part of a condition included in the received required specifications, evaluating whether or not the generated configuration plan satisfies the required specifications, updating the configuration plan according to an evaluation result, and outputting information on a configuration plan evaluated to satisfy the required specifications. According to this configuration, it is possible to present a configuration plan of an energy storage apparatus satisfying a customer's requirement while considering a constraint condition in the energy storage apparatus.

### First Embodiment

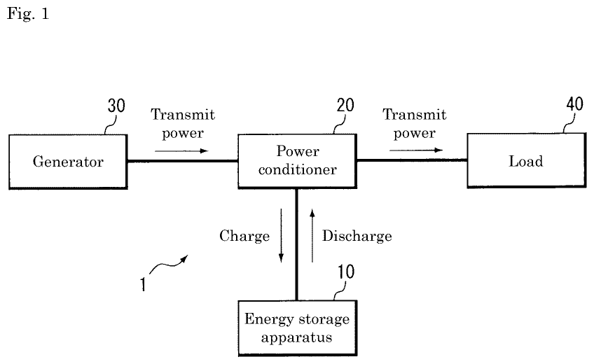

Hereinafter, the present invention will be specifically described with reference to the drawings illustrating an embodiment of the present invention. FIG. 1 is a schematic diagram illustrating a configuration example of a power supply system according to an embodiment. A power supply system 1 according to the embodiment includes an energy storage apparatus 10, a power conditioner 20, a generator 30, and a load 40. The energy storage apparatus 10 is connected to the generator 30 and the load 40 via the power conditioner 20. The generator 30 is a power supply source such as a solar cell or a wind power generator. The load 40 is various devices and facilities operated by power supplied from the energy storage apparatus 10 or the generator 30. Alternatively, the load 40 may be a drive source of a vehicle traveling or a drive source of a flying object flying by using electric power supplied by the energy storage apparatus 10 or the generator 30.

When voltage input from the generator 30 is AC voltage, the power conditioner 20 is provided with a converter that converts AC voltage into DC voltage. In this case, the power conditioner 20 supplies DC power related to DC voltage converted by the converter to the energy storage apparatus 10 and the load 40. In a case that voltage input from generator 30 is DC voltage, the power conditioner 20 may supply DC power related to input DC voltage to the energy storage apparatus 10. The energy storage apparatus 10 stores DC power supplied through the power conditioner 20. The power conditioner 20 includes an inverter for converting DC voltage input from energy storage apparatus 10 into AC voltage. The power conditioner 20 supplies AC power related to AC voltage converted by the inverter to the load 40.

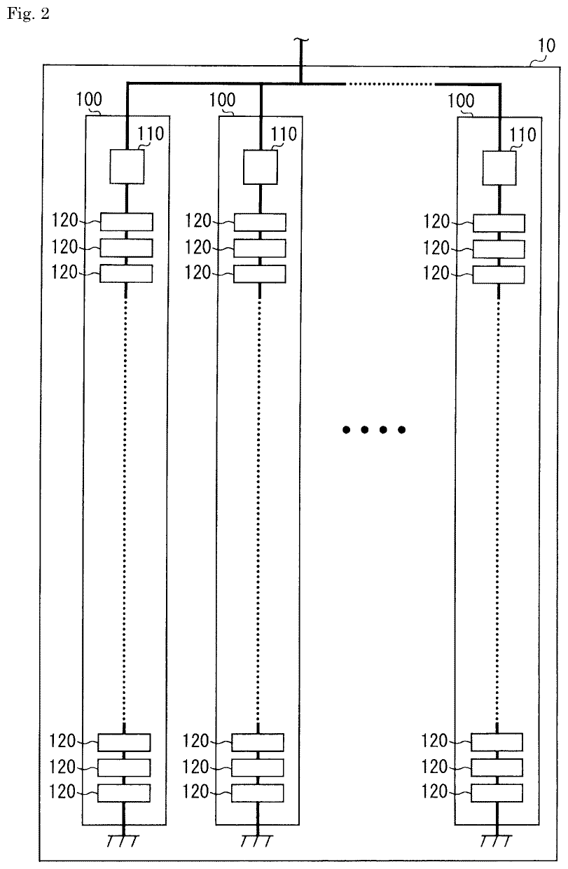

FIG. 2 is a schematic diagram illustrating a configuration example of the energy storage apparatus 10. The energy storage apparatus 10 includes K (K is an integer of one or more) banks 100 connected in parallel. In mobile applications, one end of each of the banks 100 is connected to the power conditioner 20 via a power line, and another end is grounded. For stationary use, another end of each of the banks 100 does not need to be grounded. Each of the banks 100 includes a charge-discharge circuit 110 and L (L is an integer of one or more) energy storage cells 120 connected in series. The energy storage cell 120 is, for example, a lead-acid battery. The total number of the energy storage cells 120 in the energy storage apparatus 10 is K×L (the number of parallel connections is K, and the number of series connections is L). The charge-discharge circuit 110 includes a switch or a breaker, and controls charge and discharge of each of the energy storage cells 120 by switching on and off of the switch or the breaker.

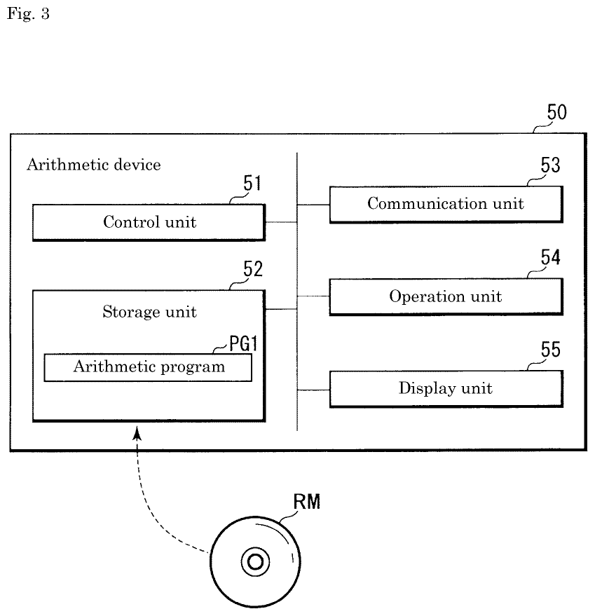

A configuration plan of the energy storage apparatus 10 including the total number of the energy storage cells 120, the number of parallel connections, and the number of series connections is prepared according to customer's required specifications. In the present embodiment, a configuration plan of the energy storage apparatus 10 is prepared using an arithmetic device 50 (see FIG. 3) to be described later. More specifically, with respect to the energy storage apparatus 10 to be designed, the arithmetic device 50 receives required specifications required by a customer, and generates a configuration plan of the energy storage apparatus 10 so as to satisfy the received required specifications.

FIG. 3 is a block diagram describing an internal configuration of the arithmetic device 50. The arithmetic device 50 is a dedicated or general-purpose computer such as a tablet terminal, a smartphone, a personal computer, or a server device. The arithmetic device 50 includes, for example, a control unit 51, a storage unit 52, a communication unit 53, an operation unit 54, and a display unit 55.

The control unit 51 includes, for example, a central processing unit (CPU), a read only memory (ROM), a random access memory (RAM), and the like. The CPU included in the control unit 51 loads various computer programs stored in the ROM or the storage unit 52 into the RAM and executes the computer programs so as to cause the entire device to function as the information output device of the present application.

Alternatively, the control unit 51 may be an optional processing circuit or arithmetic circuit including a plurality of CPUs, a multi-core CPU, a graphics processing unit (GPU), a microcomputer, a volatile or nonvolatile memory, and the like. The control unit 51 may have a function of a timer that measures elapsed time from when a measurement start instruction is given to when a measurement end instruction is given, a counter that counts the number, a clock that outputs date and time information, and the like.

The storage unit 52 includes a storage device such as a flash memory or a hard disk drive. The storage unit 52 stores various computer programs executed by the control unit 51, data necessary for executing the computer programs, and the like. One of the computer programs stored in the storage unit 52 is an arithmetic program PG1 for causing the control unit 51 to execute processing of generating a configuration plan of the energy storage apparatus 10 that conforms to customer's required specifications and outputting information on the generated configuration plan. The arithmetic program PG1 may be a single computer program or a program group including a plurality of computer programs. The arithmetic program PG1 may partially use an existing library or simulator.

Computer programs including the arithmetic program PG1 is provided by a non-transitory recording medium (program product) RM in which the computer program is readably recorded. The recording medium RM is, for example, a portable memory such as a CD-ROM, a universal serial bus (USB) memory, a secure digital (SD) card, a micro SD card, and a compact flash (registered trademark). The control unit 51 only needs to read a computer program from the recording medium RM by using a reading device (not illustrated) and install the read computer program in the storage unit 52. Alternatively, computer programs including the arithmetic program PG1 may be provided by communication. In this case, the control unit 51 may acquire computer programs including the arithmetic program PG1 by communication via the communication unit 53 and install the acquired computer program in the storage unit 52.

The communication unit 53 includes a communication interface that transmits and receives various data. The communication interface included in the communication unit 53 is, for example, a communication interface conforming to a communication standard of a LAN used in WiFi (registered trademark) or Ethernet (registered trademark). In a case where data to be transmitted is input from the control unit 51, the communication unit 53 transmits the data to be transmitted to a designated destination. In a case of receiving data transmitted from an external device, the communication unit 53 outputs the received data to the control unit 51.

The operation unit 54 includes operation devices such as a touch panel, a keyboard, and a switch, and receives various types of operation and input of data by the user. The control unit 51 performs appropriate control based on various pieces of operation information provided from the operation unit 54, and stores input data in the storage unit 52 as needed.

The display unit 55 includes a display device such as a liquid crystal display or an organic electro-luminescence (EL) display. The display unit 55 displays information to be notified to the user in response to instruction from the control unit 51. The display unit 55 may be replaced with a notification unit and may be a means for performing notification to the user by another means such as voice. Hereinafter, an example in which the display unit 55 is provided will be described. However, in a case where the display unit 55 is replaced with a notification unit that is a means for performing notification to the user by another means, notification to the user is performed by a method corresponding to a notifying means of the notification unit, a flowchart described below proceeds, and similar result and effect are obtained. Replacing the display unit 55 with a notification unit is also applicable to embodiments other than the first embodiment.

The arithmetic device 50 may be configured to receive operation through a computer connected to the outside and output information to be notified to an external computer. In this case, the arithmetic device 50 does not need to include the operation unit 54 and the display unit 55.

In the present embodiment, the arithmetic device 50 may be a single computer or a computer system including a plurality of computers, a peripheral device, and the like. Alternatively, the arithmetic device 50 may be a virtual machine whose entity is virtualized, or may be a cloud.

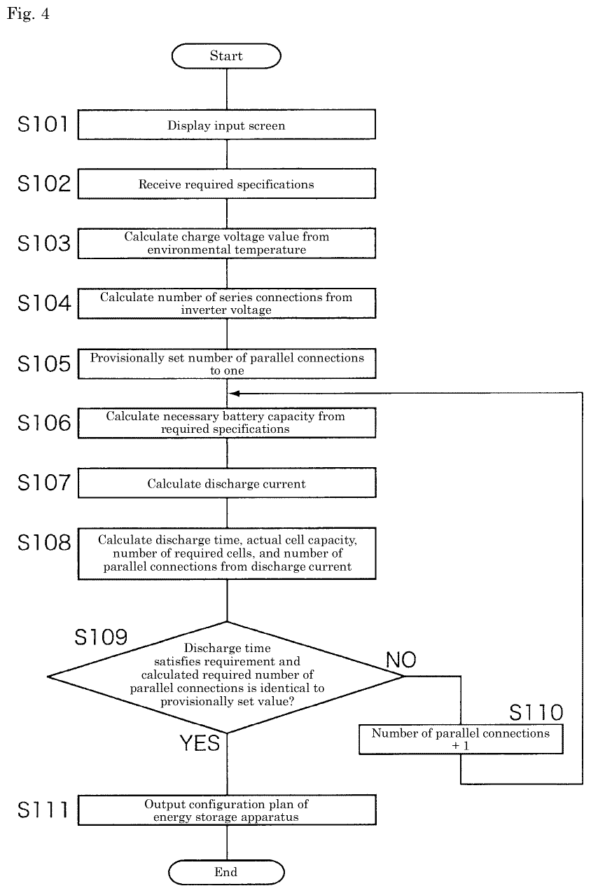

Hereinafter, operation of the arithmetic device 50 will be described. FIG. 4 is a flowchart illustrating a procedure of processing executed by the arithmetic device 50. The control unit 51 of the arithmetic device 50 executes processing below by reading and executing the arithmetic program PG1 stored in the storage unit 52.

The control unit 51 generates an input screen for receiving customer's required specifications relating to the energy storage apparatus 10, and displays the input screen on the display unit 55 (Step S101). The control unit 51 receives customer's required specifications through the input screen displayed on the display unit 55 (Step S102).

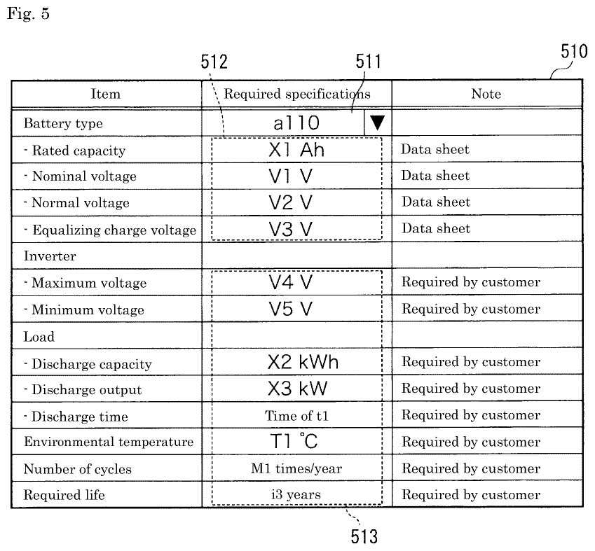

FIG. 5 is a schematic diagram illustrating an example of an input screen for receiving customer's required specifications. An input screen 510 illustrated in FIG. 5 includes a selection field 511 for receiving selection of a model of the energy storage cell 120. The selection field 511 is, for example, a pull-down menu type selection field. A sales representative (or customer) operates the operation unit 54 of the arithmetic device 50 to select a desired model of the energy storage cell 120 from the pull-down menu type selection field 511. When a model is selected in the selection field 511, the control unit 51 reads specifications of the corresponding energy storage cell 120 from a data sheet stored in the storage unit 52, and displays the specifications in a display field 512. Specifications of the energy storage cell 120 include information such as rated capacity, nominal voltage, normal voltage, and equalizing charge voltage.

The input screen 510 includes an input field 513 that receives customer's required specifications. The input field 513 receives, for example, information such as maximum voltage and minimum voltage of an inverter, discharge capacity of a load, discharge output and discharge time, environmental temperature, the number of cycles, and required life. A sales representative (or customer) operates the operation unit 54 of the arithmetic device 50 to input information related to required specifications.

After receiving customer's required specifications through the input screen 510 as illustrated in FIG. 5, the control unit 51 executes processing in and after Step S103 to create a configuration plan of the energy storage apparatus 10.

The control unit 51 refers to required specifications received in Step S102, and calculates charge voltage from environmental temperature (Step S103). Terminal voltage in the energy storage cell 120 is represented by V=E+Ir. Here, V is terminal voltage, E is electromotive force, I is charge current, and r is internal resistance. In a lead-acid battery, at low temperature, chemical reaction of internal electrolyte solution slows down, so that internal resistance increases and terminal voltage increases. In Step S103, the control unit 51 calculates charge voltage corresponding to environmental temperature.

The control unit 51 calculates the number of series connections of the energy storage cells 120 from inverter voltage (Step S104). Here, the control unit 51 calculates the number (=L) of the energy storage cells 120 connected in series in one of the banks 100. For example, the control unit 51 calculates the number of series connections of the energy storage cells 120 from V4/V3 by using equalizing charge voltage (=V3) of the energy storage cells 120 obtained from a data sheet and maximum voltage (=V4) of an inverter.

Since the number of parallel connections (=K) of the energy storage cells 120 is not determined at the present time point, the control unit 51 provisionally sets the number of parallel connections to one (Step S105).

The control unit 51 calculates necessary battery capacity from required specifications (Step S106), and calculates discharge current (Step S107). Discharge capacity, discharge time, and discharge voltage required by a customer are defined by required specifications. However, in a lead-acid battery, it is known that expected life of the energy storage cell 120 changes depending on depth of discharge, and discharge capacity changes depending on environmental temperature and a discharge rate. Battery capacity and discharge current of the energy storage apparatus 10 used at a customer's use destination are calculated in consideration of these.

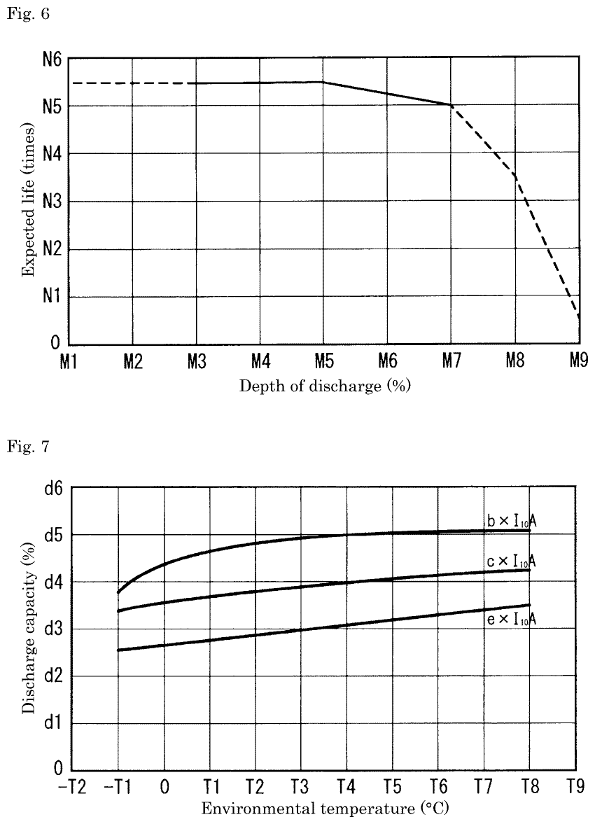

FIG. 6 is a graph showing a relationship between depth of discharge and expected life. The horizontal axis of the graph represents depth of discharge (%), and the vertical axis represents expected life (times). From required specifications, the number of cycles and life required for the energy storage apparatus 10 are set to, for example, M1 times/year and i3 years (expected life=M1×i3 times), respectively. With reference to the graph of FIG. 6, it is possible to determine an operation range of depth of discharge required to satisfy expected life.

FIG. 7 is a graph showing a relationship between environmental temperature and discharge capacity for each discharge rate. The horizontal axis of the graph represents environmental temperature (° C.), and the vertical axis of the graph represents discharge capacity (%). Here, I₁₀ represents ten hour rate current. From the graph shown in FIG. 7, it can be seen that discharge capacity changes according to environmental temperature and discharge current.

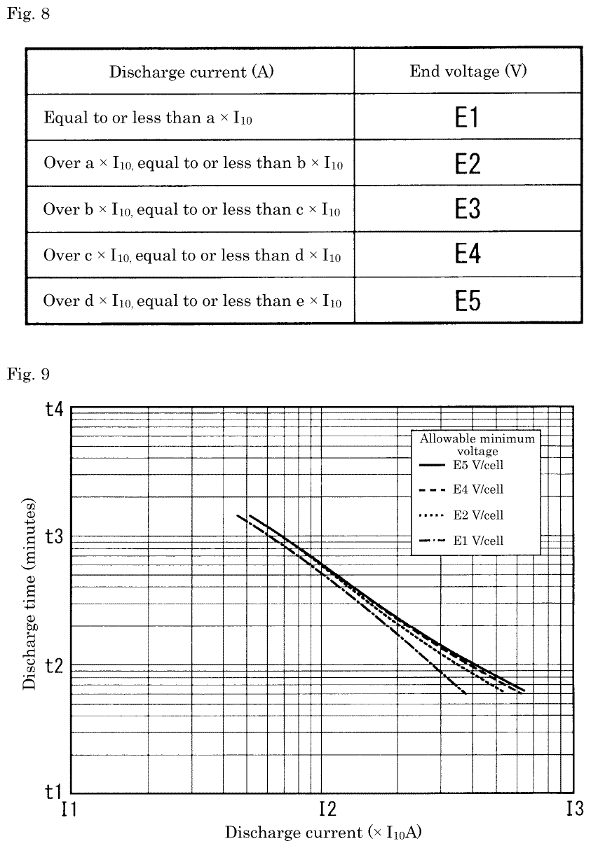

The control unit 51 refers to the graph illustrated in FIG. 6, the graph illustrated in FIG. 7, and the like based on discharge current, required life, and the like provided as required specifications, and calculates battery capacity and discharge current necessary at a customer's use destination. The arithmetic device 50 may include the graphs illustrated in FIGS. 6 and 7 as a table, or may include the graphs as a function or a library. When discharge current is calculated, end voltage is determined based on a diagram showing a relationship between discharge current and end voltage shown in FIG. 8.

The control unit 51 calculates discharge time, actual cell capacity, the number of required cells, and the required number of parallel connections based on the discharge current calculated in Step S107 (Step S108). FIG. 9 is a graph showing a relationship between discharge current and discharge time. The horizontal axis and the vertical axis of the graph are both logarithmic axes, the horizontal axis represents discharge current (×I₁₀A), and the vertical axis represents discharge time (minutes). By referring to a discharge current/discharge time characteristic shown in the graph of FIG. 9, the control unit 51 can calculate discharge time based on the discharge current calculated in Step S107. Discharge time shown on the vertical axis of the graph of FIG. 9 represents time (dischargeable time) in a case where discharge is performed to end voltage. Discharge time (maximum allowable discharge time) in a case where depth of discharge (DOD) is operated at 50% is half dischargeable time. Discharge time can be read from the graph of FIG. 9 based on the discharge current calculated in Step S107 and allowable minimum voltage of the energy storage cell 120. The arithmetic device 50 may include the graph illustrated in FIG. 9 as a table, or may include the graph as a function or a library.

Actual capacity of the energy storage cell 120 is calculated based on the discharge current calculated in Step S107 and the discharge time calculated in Step S108. Furthermore, the required number of series connections (required number of cells) and the required number of parallel connections (required number of parallel connections) of the energy storage cells 120 are calculated based on actual capacity of the energy storage cells 120.

The control unit 51 determines whether or not the calculated discharge time satisfies a requirement and the calculated required number of parallel connections is identical to a provisionally set value (Step S109). Specifically, the control unit 51 determines whether or not the maximum allowable discharge time calculated in Step S108 satisfies discharge time included in customer's required specifications. For example, in a case where the maximum allowable discharge time calculated in Step S108 is tx, discharge time included in customer's required specifications is t1, and the maximum allowable discharge time tx is longer than the discharge time t1 included in the required specifications, it is determined that the requirement is satisfied. Furthermore, since the number of parallel connections provisionally set in Step S105 is one, if the required number of parallel connections calculated in Step S108 is one, it is determined that the numbers are identical, and if the required number of parallel connections calculated in Step S108 is two or more, it is determined that the numbers are not identical.

In a case of determining that the calculated discharge time does not satisfy the request, or that the calculated required number of parallel connections is not identical to the provisionally set value (S109: NO), the control unit 51 increases the number of parallel connections set provisionally by one (Step S110), and returns the processing to Step S106.

In a case of determining that the calculated discharge time satisfies the request and determining that the calculated required number of parallel connections is identical to the provisionally set value (S109: YES), the control unit 51 outputs a configuration plan of the energy storage apparatus 10 (Step S111). Specifically, the control unit 51 causes the display unit 55 to display information on the calculated configuration plan. Alternatively, the control unit 51 may notify information on the calculated configuration plan to a terminal used by a customer by transmitting the information from the communication unit 53.

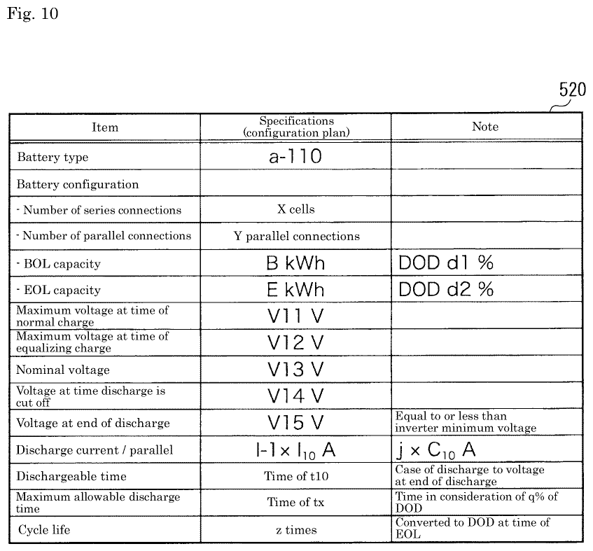

FIG. 10 is a schematic diagram illustrating an example of an output screen for displaying a configuration plan of the energy storage apparatus 10. A configuration idea displayed on an output screen 520 includes, for example, the number of series connections and the number of parallel connections of the energy storage cells 120. The number of series connections is the total number (=L) of the energy storage cells 120 connected in series in one of the banks 100, and the number of parallel connections is equal to the number of the banks 100 mounted on the energy storage apparatus 10.

A configuration plan may further include information such as capacity, charge voltage, discharge voltage, discharge current, discharge time, and cycle life of the energy storage apparatus 10. In the example of FIG. 10, BOL capacity (BOL: Beginning of Life) and EOL capacity (EOL: End of Life) are included as capacity of the energy storage apparatus 10. In the present embodiment, BOL capacity is equivalent to d1% in DOD when discharge required at an initial stage of life is performed, and EOL capacity is equivalent to d2% in DOD when discharge required at the end of life is performed.

In the example of FIG. 10, maximum voltage at the time of normal charge and maximum voltage at the time of equalizing charge are included as the charge voltage of the energy storage apparatus 10. Furthermore, nominal voltage, voltage at the time discharge is cut off, and voltage at the end of discharge are included as the discharge voltage of the energy storage apparatus 10. The nominal voltage and the voltage at the time discharge is cut off are nominal voltage of the energy storage cell 120×the number of series connections. The voltage at the end of discharge is voltage at the time of discharge with DOD of 100%. Discharge with DOD of 100% is not recommended from the viewpoint of life degradation, but discharge with a DOD of 100% may be performed as an exception at the time of emergency. However, in a case where end-of-discharge voltage is equal to or less than minimum voltage of an inverter, an operation condition is not satisfied, so that operation with DOD of 100% is impossible.

Discharge current and discharge time (dischargeable time and maximum allowable discharge time) are calculated as described above, and are displayed on the output screen 520. Cycle life is derived from, for example, a characteristic illustrated in FIG. 6. When cycle life is converted by DOD (=d2%) at the time of EOL, the cycle life is z times.

As described above, in the first embodiment, by receiving customer's required specifications in the arithmetic device 50, a configuration plan of the energy storage apparatus 10 satisfying the required specifications can be presented while a constraint condition in the energy storage apparatus 10 is considered.

### Second Embodiment

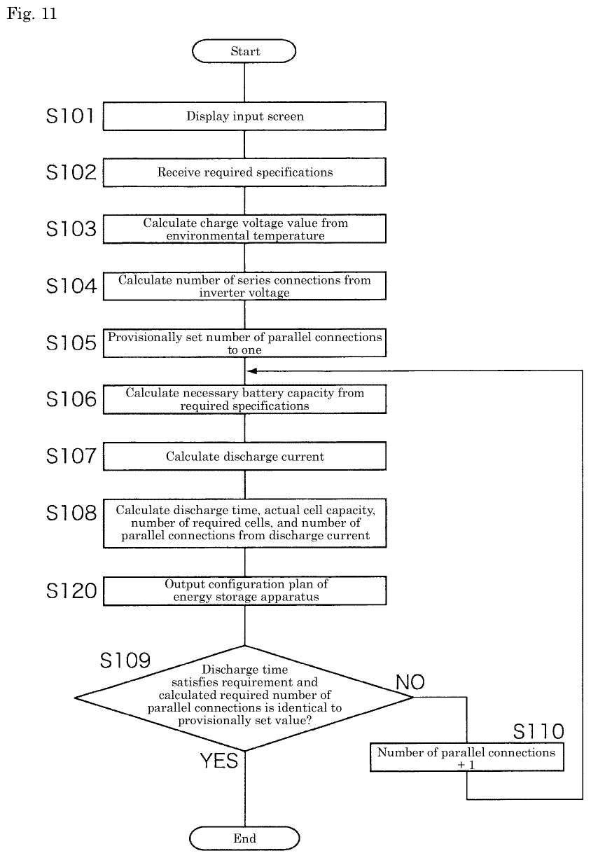

FIG. 11 is a flowchart illustrating a procedure of processing executed by the arithmetic device 50 according to a second embodiment. The arithmetic device 50 according to the second embodiment sequentially outputs not only a configuration plan finally obtained but also a configuration plan obtained as a calculation process. Since a configuration of the arithmetic device 50 and a configuration of the energy storage apparatus 10 to be designed are similar to those of the first embodiment, description of these will be omitted.

The control unit 51 of the arithmetic device 50 executes processing in the same procedure as Steps S101 to S108 of the flowchart shown in FIG. 4, and calculates information necessary for a configuration plan of the energy storage apparatus 10. After calculating discharge time, actual cell capacity, the number of required cells, and the required number of parallel connections in Step S108, the control unit 51 outputs a configuration plan in a calculation process (Step S120). Here, information such as capacity, charge voltage, discharge voltage, discharge current, discharge time, and cycle life of the energy storage apparatus 10 calculated based on a provisionally set number of parallel connections is displayed on the display unit 55. An output example is similar to that in FIG. 10. Alternatively, a configuration plan in a calculation process may be notified from the communication unit 53 to a terminal used by a customer.

In Step S109, the control unit 51 determines whether or not calculated discharge time satisfies requirement and a calculated required number of parallel connections is identical to a provisionally set value. In a case of determining that the calculated discharge time does not satisfy the request, or that the calculated required number of parallel connections is not identical to the provisionally set value (S109: NO), the control unit 51 increases the number of parallel connections set provisionally by one (Step S110), and returns the processing to Step S106. By the above, every time the number of parallel connections is increased by one, a configuration plan (that is, a configuration plan updated according to the number of parallel connections) of the energy storage apparatus 10 obtained in a calculation process is output from the display unit 55 or the communication unit 53.

In a case where it is determined that the calculated discharge time satisfies requirement and that the calculated required number of parallel connections is identical to the provisionally set value (S109: YES), the control unit 51 ends the processing by the present flowchart. In this case, a last configuration plan is output as a final plan from the display unit 55 or the communication unit 53.

As described above, in the second embodiment, not only a configuration plan finally obtained but also a configuration plan obtained in a calculation process is presented to a customer, so that it is possible to present to a customer that calculation is actually performed in consideration of various constraint conditions of the energy storage apparatus 10. Based on various constraint conditions of the energy storage apparatus 10, the number of batteries required is expected to be larger in a configuration plan in consideration of actual capacity (that is, the price is expected to be higher) than in a configuration plan calculated with rated capacity. However, since the number of series connections and the number of parallel connections according to actual capacity are shown in a calculation process, it is possible to appeal to a customer high reliability of a finally obtained configuration plan.

In the second embodiment, a configuration plan is output every time the number of parallel connections is updated. Alternatively, the control unit 51 may output a value from the display unit 55 or the communication unit 53 each time a value of the number of series connections, the number of parallel connections, capacity, charge voltage, discharge voltage, discharge current, discharge time, cycle life, or the like of the energy storage apparatus 10 is calculated.

### Third Embodiment

In a third embodiment, an application example to a lithium ion battery will be described. Since a configuration of the arithmetic device 50 is similar to that of the first embodiment, description of the arithmetic device 50 will be omitted.

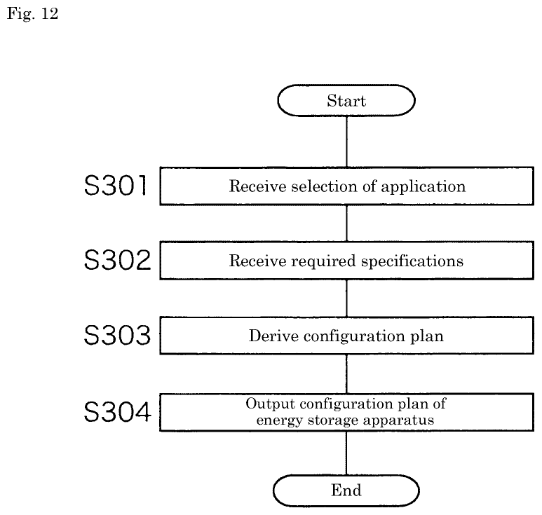

FIG. 12 is a flowchart illustrating a procedure of processing executed by the arithmetic device 50 according to a third embodiment. The control unit 51 of the arithmetic device 50 according to the third embodiment displays a selection screen (not illustrated) on the display unit 55, and receives selection of application of the energy storage apparatus 10 on the displayed selection screen (Step S301). In the energy storage apparatus 10 of the third embodiment, the energy storage apparatus 10 includes K (K is an integer of one or more) of the banks 100 connected in parallel. Each of the banks 100 includes the charge-discharge circuit 110 and M (M is an integer of one or more) energy storage modules connected in series. Each energy storage module includes N (N is an integer of one or more) of the energy storage cells 120 connected in series. In third embodiment, the energy storage cell 120 is a lithium ion battery. In Step S301, the control unit 51 receives one of application to a DC load and application to other than a DC load.

The control unit 51 receives input of required specifications according to the selected application (Step S302). The control unit 51 displays an input screen (not illustrated) according to application on the display unit 55, and receives input of required specifications on the displayed input screen. For example, in a case where application to a DC load is selected, the control unit 51 receives information such as a load pattern, environmental temperature, minimum temperature, a battery type, a cell voltage range, and expected life as required specifications. On the other hand, when application other than a DC load is selected, information such as an inverter/uninterruptible power supply (UPS) capacity, reverse conversion efficiency, a load power factor, a load voltage range, environmental temperature, minimum temperature, discharge time, a discharge frequency, a battery type, a cell voltage range, required life, a battery board type, and a battery board height is received as required specifications.

The control unit 51 derives a configuration plan of the energy storage apparatus 10 based on the received required specifications (Step S303). Similarly to the first embodiment, the control unit 51 calculates the number of series connections from the required specifications and provisionally sets the number of parallel connections. The control unit 51 calculates a necessary battery configuration while updating a provisionally set number of parallel connections in consideration of the required specifications, a maintenance factor, and a K value. In a case where application is other than a DC load, a configuration of a battery board may be calculated together with a battery configuration. When an upper limit number of the energy storage cells 120 that can be monitored in one energy storage module is determined, the control unit 51 may calculate the number (=M) of energy storage modules mounted in one of the banks 100 and the number (=N) of the energy storage cells 120 mounted in each energy storage module based on the upper limit number.

The control unit 51 outputs a configuration plan of the energy storage apparatus 10 derived in Step S303 (Step S304). Specifically, the control unit 51 causes the display unit 55 to display information on the calculated configuration plan. Alternatively, the control unit 51 may notify information on the calculated configuration plan to a terminal used by a customer by transmitting the information from the communication unit 53.

As described above, in the third embodiment, a configuration plan can be presented to a customer regarding the energy storage apparatus 10 including a lithium ion battery as the energy storage cell 120.

The disclosed embodiments are illustrative in all respects and not restrictive. The scope of the present invention is defined by the claims, and includes meanings equivalent to the claims and all changes within the scope.

For example, in the above-described embodiment, a lead-acid battery and a lithium ion battery are described as an example, but the present invention is not limited to this, and other batteries, a medium capable of storing electricity, a medium capable of storing energy, and the like are also applicable.

Independent claims and dependent claims described in the claims can be combined with each other in all combinations regardless of the form of citation. Furthermore, a form (multi-claim form) in which claims referring to two or more other claims are described is used in the claims, but the present invention is not limited to this. The claims may be described using a form in which a multiple claim referring to at least one multiple claim (multiple dependent claim) is described.

1. An information output device comprising:
a receiving unit that receives input of a required specification related to an energy storage apparatus to be designed;
a generation unit that generates a configuration plan of the energy storage apparatus including a number of energy storage cells to be mounted on the energy storage apparatus and arrangement of the energy storage cells based on a part of a condition included in the received required specifications;
an evaluation unit that evaluates whether or not the generated configuration plan satisfies the required specification;
an update unit that updates the configuration plan according to an evaluation result of the evaluation unit and causes the evaluation unit to evaluate an updated configuration plan; and
an output unit that outputs information on a configuration plan evaluated by the evaluation unit to satisfy the required specification.

2. The information output device according to claim 1, wherein the required specification includes discharge specification and voltage converted by an inverter included in a power supply system with respect to power discharged from the energy storage apparatus.

3. The information output device according to claim 2, wherein the generation unit generates the configuration plan by calculating a number of series connections of the energy storage cells and provisionally setting a number of parallel connections of the energy storage cells based on voltage converted by an inverter included in the power supply system and a specification of the energy storage cell with respect to power discharged from the energy storage apparatus.

4. The information output device according to claim 3, wherein the evaluation unit calculates a number of series connections and a number of parallel connections of energy storage cells required from a discharge specification of the energy storage apparatus, and evaluates whether or not the configuration plan satisfies the required specification according to whether or not a provisionally set number of parallel connections and a calculated number of parallel connections coincide with each other.

5. The information output device according to claim 3, wherein the evaluation unit derives maximum allowable discharge time from discharge current calculated based on the configuration plan, and evaluates whether or not the configuration plan satisfies the required specification according to whether or not derived maximum allowable discharge time satisfies discharge time given as the discharge specification.

6. The information output device according to claim 3, wherein the update unit changes a provisionally set number of parallel connections in a case where the evaluation unit evaluates that the configuration plan does not satisfy the required specification.

7. The information output device according to claim 1, further comprising a display unit that displays a receiving screen for receiving input of the required specification.

8. An information output method that executes, by a computer, processing of:
receiving input of a required specification related to an energy storage apparatus to be designed;
generating a configuration plan of the energy storage apparatus including a number of energy storage cells to be mounted on the energy storage apparatus and arrangement of the energy storage cells based on a part of a condition included in the received required specification;
evaluating whether or not the generated configuration plan satisfies the required specification;
updating the configuration plan according to an evaluation result; and
outputting information on a configuration plan evaluated to satisfy the required specification.

9. A computer program that causes a computer to execute processing of:
receiving input of a required specification related to an energy storage apparatus to be designed;
generating a configuration plan of the energy storage apparatus including a number of energy storage cells to be mounted on the energy storage apparatus and arrangement of the energy storage cells based on a part of a condition included in the received required specification;
evaluating whether or not the generated configuration plan satisfies the required specification;
updating the configuration plan according to an evaluation result; and
outputting information on a configuration plan evaluated to satisfy the required specification.
